(19) United States
(12) Patent Application Publication
(10) Pub. No.: US 2016/0178559 A1
(43) Pub. Date: Jun. 23, 2016

(54) UNIVERSAL STRIP PORT CONNECTOR

(71) Applicant: LifeScan Scotland Limited, Inverness (GB)

(72) Inventors: David ELDER, Inverness (GB); George Mark POMEROY, Inverness (GB)

(21) Appl. No.: 14/573,385

(22) Filed: Dec. 17, 2014

(51) Int. Cl. G01N 27/327; H01R 13/66

(52) U.S. Cl. CPC G01N 27/3273; G01N 27/3272; H01R 13/665

(57) ABSTRACT

The test meter includes a strip port connector configured and sized to receive a test strip and including a plurality of spaced electrical contacts disposed in an array upon a printed circuit board (PCB). Upon insertion of a test strip in the strip port connector, at least some of the plurality of spaced electrical contacts of the strip port connector are caused to engage each of the electrical contacts of the inserted test strip and in which a plurality of disparate test strip designs can be used in connection with the test meter and in which the array of electrical contacts of the strip port connector are disposed in parallel relation to the substantially planar surface of the inserted test strip and are brought into contact therewith for identifying the test strip and subsequent testing.

### TECHNICAL FIELD

This application generally relates to the field of blood analyte measurement systems and more specifically to portable analyte measurement devices that are configured to interact with numerous and/or disparate test strip designs.

### BACKGROUND

Blood glucose measurement systems typically comprise an analyte measurement device (e.g., a portable test meter) that is configured to receive a biosensor, usually in the form of a test strip. Because many of these analyte determination systems are portable, and testing may be completed in a short amount of time, patients are able to use such devices in the normal course of their daily lives without significant interruption to their personal routines. As a result, a person with diabetes may measure their blood glucose levels several times a day as a part of a self management process to ensure glycemic control of their blood glucose within a target range. A failure to maintain target glycemic control may result in serious diabetes-related complications including cardiovascular disease, kidney disease, nerve damage and blindness.

There currently exist a number of available portable electrical analyte measurement devices that are designed to automatically activate upon insertion of a test strip into a port of the device, e.g., a test meter. Electrical contacts, or prongs, in a strip ort connector of the test meter establish connections with contact pads provided on the test strip. However, current analyte measurement devices are only capable of interacting with a test strip model with which they are initially designed to interact. When a new test strip model, including newly designed electrical contacts, is released or replaces a previous model, a new analyte measurement device, designed to interact with the new test strip model, must also be released. Designing and manufacturing this latter analyte measurement device model can be costly in time and resources for the manufacturers. Also, manufacturers and distributors are often left with unsold previous models that must be disposed of in some manner, resulting in a loss of profits. Furthermore, the release of new meter designs equipped to utilize the new test strip designs are costly and require consumers to purchase a new analyte measurement device to work with the new test strip model, even if the consumer's previous test meter was still functional.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates a front facing view of an exemplary test strip based analyte measurement system;

FIG. 1B illustrates a diagrammatic view of an exemplary processing system of the test strip based analyte measurement system of FIG. 1A;

FIG. 2A illustrates a partial cross-sectional side view of an exemplary strip port connector;

FIG. 2B illustrates a cross-sectional side view of the exemplary strip port connector of FIG. 2A, as coupled to a test strip;

FIG. 3A illustrates an array of spaced electrical contacts of an exemplary strip port connector;

FIG. 3B illustrates the array of spaced electrical contacts of FIG. 3B, as coupled to the electrical contacts of exemplary test strips;

FIG. 4 illustrates an exemplary connection of a plurality of electrical contacts of a strip port connector to a control circuit;

FIG. 5 illustrates an exemplary test strip; and

FIG. 6 illustrates a flow chart of a method of a test strip with an analyte measurement system having an exemplary strip port connector.

### DETAILED DESCRIPTION

The following detailed description should be read with reference to the drawings, in which like elements in different drawings are identically numbered. The drawings, which are not necessarily to scale, depict selected embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. Throughout the course of discussion, several terms are used in order to describe the salient features that are provided in the accompanying drawings. These terms, which can include, “upper”, “lower”, “top”, “bottom”, distal”, “proximal” and the like are not intended to overly restrict the scope of the herein described system and method, except where expressly indicated.

As used herein, the terms “patient” or “user” refer to any human or animal subject and are not intended to limit the systems or methods to human use, although use of the subject invention in a human patient represents a preferred embodiment.

The term “sample” means a volume of a liquid, solution or suspension, intended to be subjected to qualitative or quantitative determination of any of its properties, such as the presence or absence of a component, the concentration of a component, e.g., an analyte, etc. The embodiments of the present invention are applicable to human and animal samples of whole blood. Typical samples in the context of the present invention as described herein can include blood, plasma, red blood cells, serum and suspensions thereof.

The term “about” as used in connection with a numerical value throughout the description and claims denotes an interval of accuracy, familiar and acceptable to a person skilled in the art. The interval governing this term is preferably +10%. Unless specified, the terms described above are not intended to narrow the scope of the invention as described herein and according to the claims.

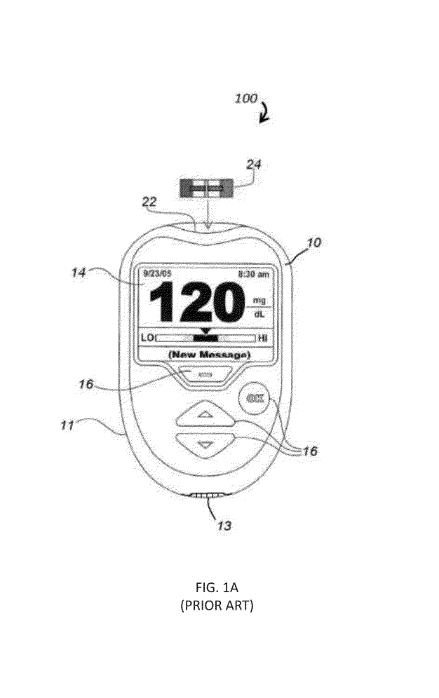

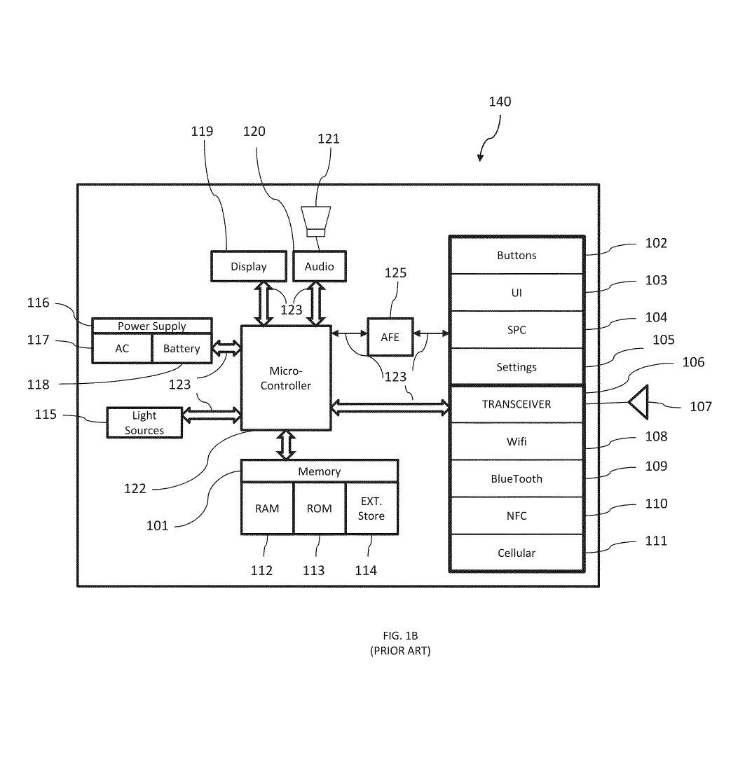

FIG. 1A illustrates an analyte measurement system 100 that includes an analyte measurement device 10. The analyte measurement device 10 is defined by a housing 11 that retains a data management unit (hereinafter also referred to as a “DMU”) 140 and further includes a port 22 sized for receiving a biosensor. According to one embodiment, the analyte measurement device 10 may be a hand held blood glucose meter with the biosensor being provided in the form of an analytical test strip 24 that is configured for insertion into a test strip port 22 for performing blood glucose measurements. The analyte measurement device 10 further includes a plurality of user interface buttons 16, and a display 14 as illustrated in FIG. 1A. A predetermined number of glucose test strips may be stored in the housing 11 and made accessible for use in blood glucose testing. The plurality of user interface buttons 16 are associated with the DMU 140 and can be configured to allow the entry of data, to prompt an output of data, to navigate menus presented on the display 14, and to execute commands. Output data can include values representative of analyte concentration presented on the display 14. Input information may include information related to the everyday lifestyle of an individual, such as food intake, medication use, occurrence of health check-ups, and general health condition and exercise levels of an individual. These inputs can be requested via prompts presented on the display 14 and can be stored in a memory module of the analyte measurement device 10. Specifically and according to this exemplary embodiment, the user interface buttons 16 include markings, e.g., up-down arrows, text characters “OK”, etc, which allow a user to navigate through the user interface presented on the display 14. Although the buttons 16 are shown herein as separate switches, a touch screen interface on display 14 with virtual buttons may also be utilized. Additional details regarding the features of the exemplary analyte test meter can be found in pending U.S. patent application Ser. No. 13/921,610, entitled “Orientation Independent Meter”, the entirety of which is herein incorporated by reference.

The electrical components of the analyte measurement system 100 can be disposed on, for example, a printed circuit board situated within the housing 11 and forming the DMU 140 of the herein described system 100. FIG. 1B illustrates, in simplified schematic form, several of the electrical subsystems disposed within the housing 11 for purposes of this embodiment. More specifically, the DMU 140 includes a processing unit 122 in the form of a microprocessor, a microcontroller, an application specific integrated circuit (“ASIC”), a mixed signal processor (“MSP”), a field programmable gate array (“FPGA”), or a combination thereof, and is electrically connected to various electrical modules included on, or connected to, the printed circuit board, as will be described below. The processing unit 122 is electrically connected to, for example, a test strip port connector 104 (hereinafter also synonymously referred to as an“SPC”) via an analog front end (“AFE”) subsystem 125. The AFE 125 is electrically connected to the strip port connector 104 during blood glucose testing. To measure a selected analyte concentration, the AFE 125 detects a resistance magnitude change across electrodes of analyte test strip 24 which indicates that a blood sample has been applied thereto, using a potentiostat. At a predetermined time after the blood sample has been applied to the test strip 24, a preset voltage waveform is applied across the sample via the electrodes which generates an electric current therethrough. The AFE 125 converts the electric current measurement into digital form for presentation on the display 14. The processing unit 122 can be configured to receive input from the strip port connector 104, analog front end subsystem 125, and may also perform a portion of the potentiostat function and the current measurement function.

The analytical test strip 24 can be in the form of an electrochemical glucose test strip, of which various embodiments are described below. The test strip 24 is defined by a nonporous substrate that can include one or more working electrodes. More specifically a typical analytical test strip 24 can also include a plurality of electrical contacts, where each electrode can be in electrical communication with at least one electrical contact. The strip port connector 104 can be configured to electrically interface to the electrical contacts, using a plurality of electrical contacts arranged on a PCB, and form electrical communication with the electrodes. A usual configuration of a strip port connector includes a set of prongs that are configured to engage the electrical contacts of an inserted test strip. As discussed herein and in contrast to previously known strip port connectors, the strip port connector 104 (shown only schematically in FIG. 1B) of this application does not include prongs but rather is defined by a plurality of spaced electrical contacts disposed in a one or two dimensional array onto the PCB that is in parallel relation to an inserted test strip. As further discussed herein, the array of electrical contacts of the SPC 104 is configured such that certain contacts will engage electrical contacts of different or various test strip designs having different electrical contract configurations. The herein defined system can allow an inserted test strip to be identified and wherein only the spaced electrical contacts of the SPC 104 in physical contact with those of the inserted test strip are actually made active for testing by the test meter.

In terms of additional background, the test strip 24 can include a reagent layer that is disposed over one or more electrodes within the test strip 24, such as a working electrode. The reagent layer can include an enzyme and a mediator. Exemplary enzymes suitable for use in the reagent layer include glucose oxidase, glucose dehydrogenase (with pyrroloquinoline quinone co-factor, “PQQ”), and glucose dehydrogenase (with flavin adenine dinucleotide co-factor, “FAD”). An exemplary mediator suitable for use in the reagent layer includes ferricyanide, which in this case is in the oxidized form. The reagent layer can be configured to physically transform glucose in the applied sample into an enzymatic by-product and in the process generate an amount of reduced mediator (e.g., ferrocyanide) that is proportional to the glucose concentration of the sample. The working electrode can then be used to apply the preset voltage waveform to the sample and to measure a concentration of the reduced mediator in the form of an electric current. In turn, microcontroller 122 can convert the current magnitude into a glucose concentration for presentation on the display 14. An exemplary analyte measurement device performing such current measurements is described in U.S. Patent Application Publication No. US 2009/0301899 A1 entitled “System and Method for Measuring an Analyte in a Sample” and in International Patent Application Publication No. WO 2012/091728 A1 entitled “Systems and Methods for High Accuracy Analyte Measurement”, which are incorporated by reference herein as if fully set forth in this application.

A display module 119, which may include a display processor and display buffer, is electrically connected to the processing unit 122 over the electrical interface 123 for receiving and displaying output data, and for displaying user interface input options under control of processing unit 122. The structure of the user interface, such as menu options, is stored in the user interface module 103 and is accessible by processing unit 122 for presenting menu options to a user of the blood glucose measurement system 100. An audio module 120 includes a speaker 121 for outputting audio data received or stored by the DMU 140. Audio outputs can include, for example, notifications, reminders, and alarms, or may include audio data to be replayed in conjunction with display data presented on the display 14. Such stored audio data can be accessed by processing unit 122 and executed as playback data at appropriate times. A volume of the audio output is controlled by the processing unit 122, and the volume setting can be stored in settings module 105, as determined by the processor or as adjusted by the user. User input module 102 receives inputs via user interface buttons 16 which are processed and transmitted to the processing unit 122 over the electrical interface 123. The processing unit 122 may have electrical access to a digital time-of-day clock connected to the printed circuit board for recording dates and times of blood glucose measurements, which may then be accessed, uploaded, or displayed at a later time as necessary.

The display 14 can alternatively include a backlight whose brightness may be controlled by the processing unit 122 via a light source control module 115. Similarly, the user interface buttons 16 may also be illuminated using LED light sources electrically connected to processing unit 122 for controlling a light output of the buttons. The light source module 115 is electrically connected to the display backlight and processing unit 122. Default brightness settings of all light sources, as well as settings adjusted by the user, are stored in a settings module 105, which is accessible and adjustable by the processing unit 122.

A memory module 101, that includes but is not limited to volatile random access memory (“RAM”) 112, a non-volatile memory 113, which may comprise read only memory (“ROM”) or flash memory, and a circuit 114 for connecting to an external portable memory device, for example, via a USB data port, is electrically connected to the processing unit 122 over a electrical interface 123. External memory devices may include flash memory devices housed in thumb drives, portable hard disk drives, data cards, or any other form of electrical storage devices. The on-board memory can include various embedded applications and stored algorithms in the form of programs executed by the processing unit 122 for operation of the analyte measurement device 10. On board memory can also be used to store a history of a user's blood glucose measurements including dates and times associated therewith. Using the wireless transmission capability of the analyte measurement device 10 or the data port 13, as described below, such measurement data can be transferred via wired or wireless transmission to connected computers or other processing devices.

A wireless module 106 may include transceiver circuits for wireless digital data transmission and reception via one or more internal digital antennas 107, and is electrically connected to the processing unit 122 over electrical interface 123. The wireless transceiver circuits may be in the form of integrated circuit chips, chipsets, programmable functions operable via processing unit 122, or a combination thereof. Each of the wireless transceiver circuits is compatible with a different wireless transmission standard. For example, a wireless transceiver circuit 108 may be compatible with the Wireless Local Area Network IEEE 802.11 standard known as WiFi. Transceiver circuit 108 may be configured to detect a WiFi access point in proximity to the analyte measurement device 10 and to transmit and receive data from such a detected WiFi access point. A wireless transceiver circuit 109 may be compatible with the Bluetooth protocol and is configured to detect and process data transmitted from a Bluetooth beacon in proximity to the analyte measurement device 10. A wireless transceiver circuit 110 may be compatible with the near field communication (“NFC”) standard and is configured to establish radio communication with, for example, another NFC compliant device in proximity to the analyte measurement device 10. A wireless transceiver circuit 111 may comprise a circuit for cellular communication with cellular networks and is configured to detect and link to available cellular communication towers.

As shown in FIG. 1B, the power supply module 116 is electrically connected to all modules in the housing 11 and to the processing unit 122 to supply electric power thereto. The power supply module 116 may comprise standard or rechargeable batteries 118 or an power supply 117, such as an AC power supply 117 or a universal serial bus (USB) power supply, may be activated when the analyte measurement device 10 is connected to a source of AC power. The power supply module 116 is also electrically connected to processing unit 122 over the electrical interface 123 for supplying power thereto and so that processing unit 122 can monitor a power level remaining in a battery power mode of the power supply module 116.

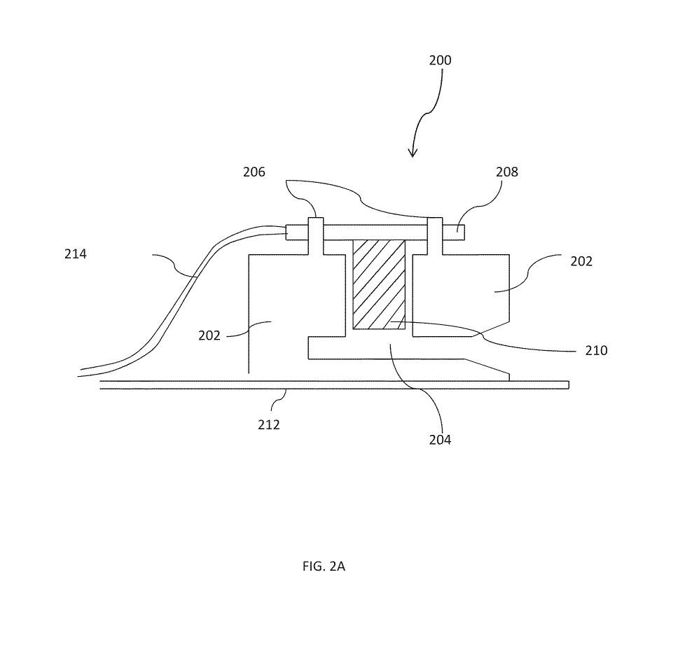

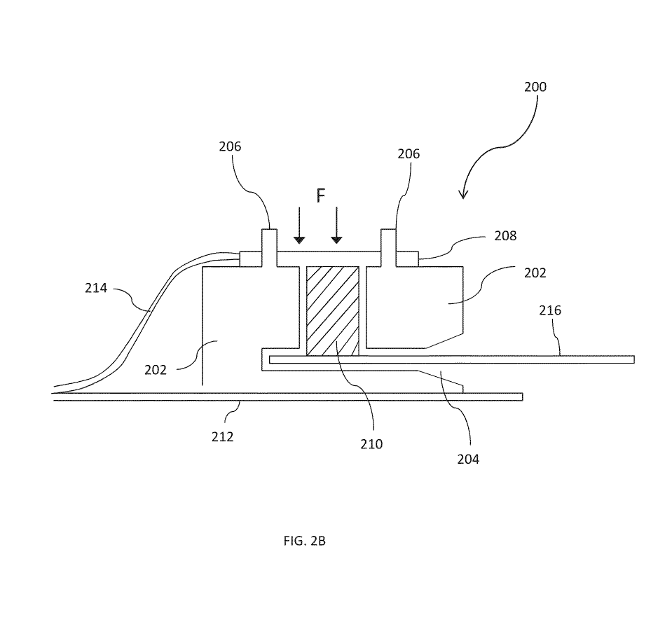

FIG. 2A illustrates a partial cross-sectional side view of an exemplary strip port connector 200 of a test meter that may be used for analyte measurement. The strip port connector 200 is defined by a body 202 that includes a recess or port 204 appropriately sized for receiving a test strip. The body 202 of the strip port connector 200 also includes a number of supports 206 configured for supporting a contact printed circuit board (PCB) 208. The supports 206 can be any suitable type of support, such as a dowel. In the herein described embodiment, the supports 206 are disposed above the recess 204 in the strip port connector 200.

The PCB 208 includes a plurality of electrical contacts 210 that are mounted thereto. More specifically, the electrical contacts 210 can be spaced apart in an array disposed on the PCB 208. By way of example, the array can include a single linear one dimensional array of spaced contacts that are disposed in a direction which is orthogonal to the test strip insertion direction. One suitable form of connector is manufactured under the tradename of Zebra connectors manufactured by Fujipoly, among others although other connector designs having pluralities of spaced electrical contacts may also be utilized. For example and alternatively, the plurality of electrical contacts can be formed from a planar section of insulating material such as silicone having a series of holes disposed in rows and columns (i.e., a two dimensional plurality of openings), each hole being filled with an electrically conductive material.

FIG. 2A illustrates a side view depicting a single one dimensional row or array of spaced electrical contacts 210 of the strip port connector 200, prior to insertion of a test strip. In this view, only a single electrical contact 210 is shown, fixedly attached by known means to the PCB 208 and disposed above the port 204 within a vertical opening or slot formed within the body 202. As shown, the strip port connector 200 may be coupled to a main PCB 212 of the analyte measurement device (test meter). More specifically, and according to this exemplary embodiment, the contact PCB 208 is electrically coupled to the main PCB 212, such as by means of a highly flexible electrical coupling 214. The main PCB 212 is electrically connected to the AFE 125, FIG. 1B, or other control circuitry of the test meter.

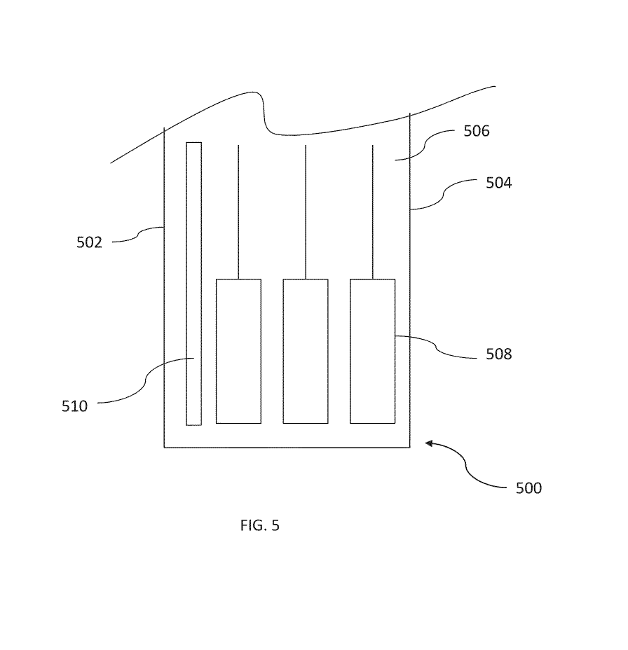

Referring to FIG. 2B, the interaction between the electrical contact 210 of the exemplary strip port connector 200 and an inserted test strip 216 is depicted. The test strip 216 is received in the recess or port 204 of the strip port connector body 202 and advanced axially. As noted, the test strip 216 includes a series of electrical contacts disposed on a substantially planar surface of the test strip 216, such as those illustrated in FIG. 5. As illustrated in FIG. 2B, when the test strip 216 is inserted in the recess 204, the electrical contacts 210 of the strip port connector 200 being disposed in parallel relation above the substantially planar surface of the inserted test strip 216 are caused to move from an initial position as shown in FIG. 2A to a second position, as shown in FIG. 2B, in which the PCB 210 is moved downwardly toward the inserted test strip 216 in the force direction labeled F and creating physical connection with the test strip 216. The amount of force F actually applied depends on the design of the test strip 216 and the strip port connector 200. Factors related to the amount of force F include the material of the test strip contacts, the need to compensate for potential contamination, the contact resistance required, the surface finish quality of the contacts 210 and the design of the electrical contacts of the test strip.

Various means can be utilized for moving the PCB 208 and array of electrical contacts 210 from the first position to the second position. For example and according to one version, a mechanical mechanism (not shown) employing a cam could be utilized having an actuable switch or other control on the housing of the meter. In another version, a light sensor (not shown) can detect the presence of the strip in the port 204 and automatically cause the PCB 208 to be moved toward the test strip 216 along the supports 206 using an electrically powered mechanism, such as a solenoid or motor (not shown). It will be readily apparent that other suitable techniques for enabling this movement can be contemplated. Since the test strip 216 is releasably attached to the test meter, the mechanism is enabled to move the PCB 208 along the supports 206 and electrical contacts 210 to the initial position of FIG. 2A in order to permit removal of the test strip after a test has been conducted. Uniquely and when moving between the first position and the second position, the PCB 208 and contacts 210 move in a direction that is substantially transverse to the substantially planar surface of the test strip 216, which allows a plurality of different test strips having differently and/or disparately located contacts to be accessible by at least some of the contacts 210 of the strip port connector 200.

In another version, the recess of the test strip connector can include a ramped shape (not shown) that causes a inserted test strip to bring the test strip 216 and the electrical contacts into direct engagement with the electrical contacts 210 of the strip port connector 200.

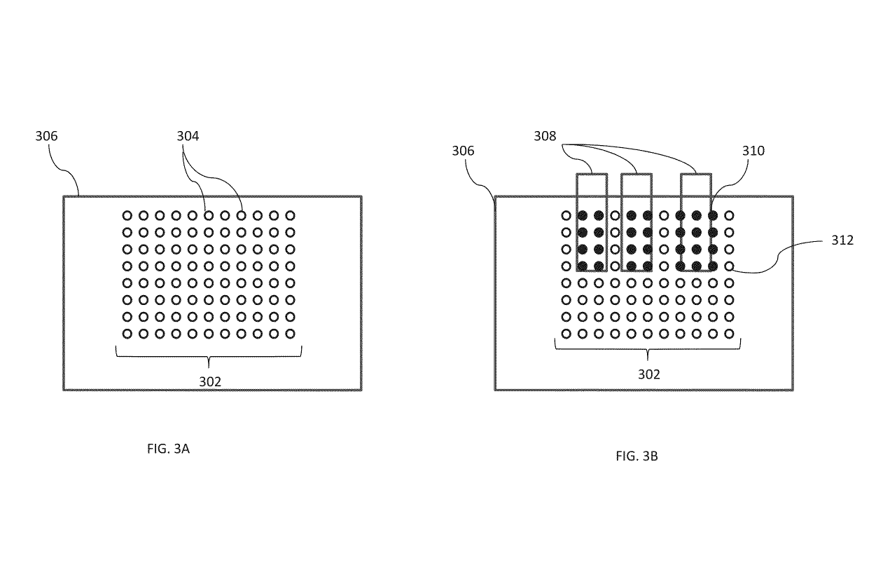

Though a one dimensional linear array of contacts 210 is shown in FIGS. 2A and 2B, electrical contacts of the strip port connector can alternatively be spaced apart and arranged in a two-dimensional (2D) array that includes multiple rows and columns of electrical contacts 304 as shown partially in FIGS. 3A and 3B. The spaced apart contacts 304 and the electrical contact areas 308 of the test strip can be formed of any suitable conducting material. Examples of suitable conducting materials include copper, gold, silver, tin, copper alloy, and combinations thereof. For example, the spaced apart contacts 304 and the electrical contact areas 308 of the test strip can be made from copper with a corrosion resistant plating. The spaces between the spaced apart contacts 304 can be filled with an insulating material such as silicone, although literally any suitable type of insulating material can be used. In an example, the contacts pads 304 can be formed onto the PCB 306 through typical etching and deposition processes used for forming copper pads and traces for electronic component assembly.

Irrespective of the design of the formed array, the principle of operation is similar to that previously described according to FIGS. 2A and 2B. Referring to FIGS. 3A and 3B, and when a test strip (shown partially) is inserted in the strip port connector as shown schematically in FIG. 3B, each of the contact areas 308 of the inserted test strip 310 are caused to make physical contact with a portion 310 of the spaced apart electrical contacts 304 such as through movement of the PCB from the initial position to the second position. In an example, this physical contact is facilitated through a “zebra” style rubber or silicone contact.

In order for the test meter to identify the specific test strip that has been inserted, a potential such as in the order of 10 mV to 5V, is applied to the electrical contacts 304 of the connector and current that is generated is measured across adjacent contacts to identify the presence of any short circuits in the array 302 of contacts 304. More specifically, an identified short in the array 302 indicates a physical connection between electrical contacts 304, 308 wherein a specific pattern, such as shown in FIG. 3B, made up of contacts 310 can be deduced by the test meter. Preferably, the spacing between the contacts 304 of the array is at least twice the spacing between the test strip contacts 308. This relative spacing prevents adjacent test strip electrical contacts 308 from being shorted by the same spaced apart contact 304. Short circuits are not created at any of the remaining contacts 312 where, as the remaining contacts 312 are not in electrical connection to any of the strip contacts, no current can flow through these contacts 312.

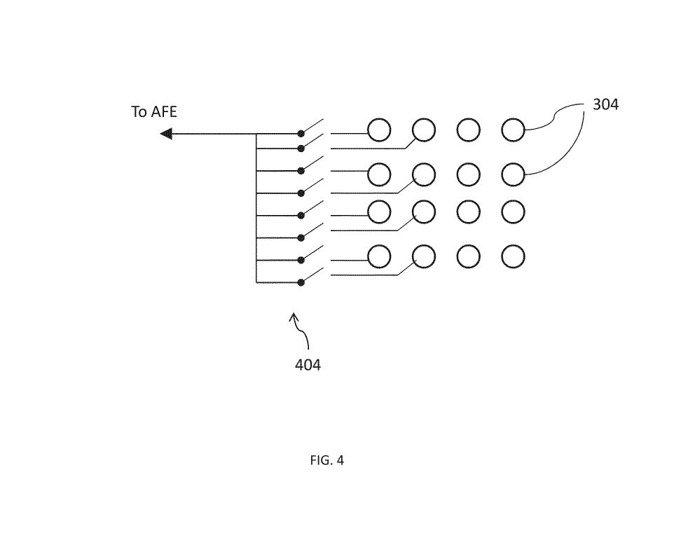

FIG. 4 illustrates an exemplary schematic connection of a plurality of electrical contacts 304 to a control circuit of the test meter. The plurality of electrical contacts 304 can be arranged in an array on a PCB (not shown in this view). Each of the electrical contacts 304 is coupled to an addressable switch 404. The addressable switches 404 couple the electrical contacts 304 to a control circuit, such as an AFE 125, FIG. 1B, of the test meter. Following the application of the initial potential to determine the applicable pattern of contacts 310, FIG. 3B, to be used by the test meter, the switches to all other contacts 312, FIG. 3B, are caused to remain open during testing. When an electrical contact 304 is determined to be in physical contact with an electrical contact area of an inserted test strip, the addressable switch 304 relating to that corresponding contact is closed. When the switch 404 is closed, an electrical connection is established between the contact 304 and the corresponding electrical contact of the test strip, allowing the test meter to identify and appropriately test the identified test strip.

FIG. 5 illustrates another exemplary test strip 500. The test strip 500 is defined by a nonporous substrate including includes strip edges 502, 504 and a planar surface 506. A plurality of contact areas 508 are arranged on the planar surface 506 of the test strip 500. According to this embodiment, three (3) elongated contact areas 508 are provided in spaced relation to each other, but the size, number and spacing of these areas can be suitably varied. As in the preceding, the electrical contact areas 508 are configured to make physical contact with some of an array of spaced apart electrical contacts of a strip port connector and to identify a pattern of the strip port connector contacts, such as those depicted in FIG. 3B. According to this embodiment, the test strip 500 can also include a contact alignment bar 510 adjacent one of the strip edges 502. This latter optional feature allows the strip port connector to align with the contact alignment bar 510 rather than the test strip edge 502, 504. More specifically, the strip port connector can be configured to determine or identify the presence of the contact alignment bar 510 by measuring for electrical continuity across two or more spaced apart strip port connector electrical contacts that are presumed to be connected to the alignment bar. When the test strip is inserted, the test meter can be configured using a control circuit to generate the potential, e.g., 10 mV to 5V, across the contacts and measuring the current, as previously discussed. Pattern recognition for the contact alignment bar 510 can be very basic. For example, pattern recognition can be conducted using a stored scanning algorithm that increments the x-position (width) of the array of strip port connector electrical contacts until a first electrical contact (short circuit) is established.

After a strip port connector has established a connection with the electrical contacts 508 of the test strip 500, the pattern of the test strip electrical contacts 508 can be programmed or stored into memory of the analyte measurement device (e.g., test meter). When a test strip with the same pattern is inserted in the analyte measurement device, the analyte measurement device can recognize the pattern and activate the appropriate strip port connector electrical contacts. The herein described strip port connector enables electrical contact to be established with a varied number of test strips having different or disparately located contact areas in which each inserted test strip can be identified prior to testing and in which the test meter can be suitably configured for performing the testing. For example and when a new test strip model is released, the pattern of the electrical contact areas of the test strip can be determined and stored or otherwise used by the analyte measurement device for testing of the inserted test strip and additional test strips from the same or different family (design).

In all of the above examples illustrated in FIGS. 2A-5 and after the pattern of the test strip electrical contacts has been determined, identifying the appropriate test strip, a suitable test waveform applicable to the test strip identified can be applied to the electrodes of the test strip having an applied sample via the strip port connector that mechanically and electrically interconnects the inserted test strip to the test meter.

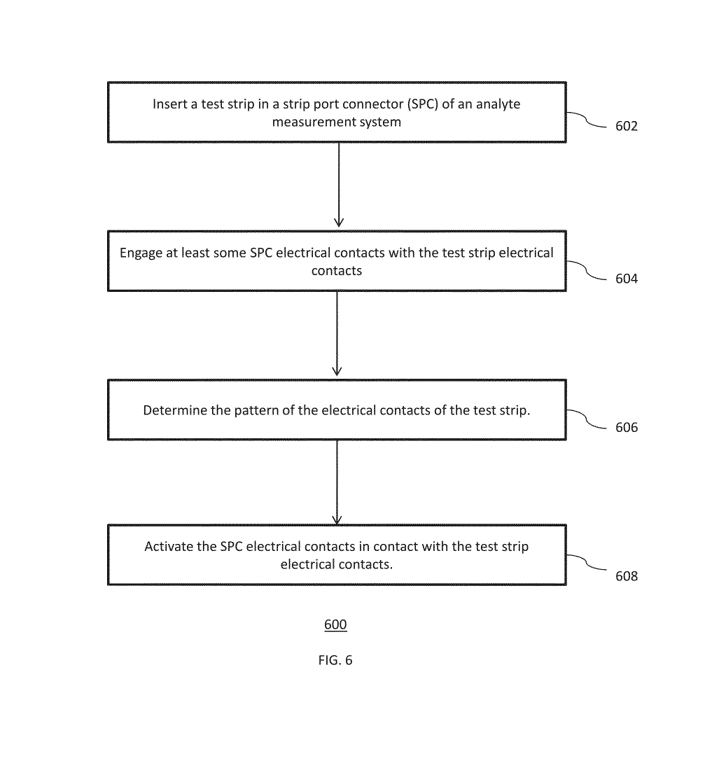

FIG. 6 illustrates a flow chart demonstrating an exemplary method 600 of operating an analyte measurement device 100 as described herein. At block 602, a test strip in a strip port connector of an analyte measurement device is inserted in the analyte measurement device. The strip port connector includes a plurality of spaced electrical contacts arranged in an array. The array can be a one dimensional linear array or a 2 dimensional array, as described above. The array is supported onto a surface of a PCB.

At block 604, the pattern of electrical contacts or contact areas of the inserted test strip is determined such as by physically moving the array of electrical contacts of the strip port connector into direct contact with the test strip. In an embodiment, the pattern of electrical contacts is determined by identifying applying an appropriate voltage across the PCB and determining by measuring current across the various contacts. The detection of the resulting pattern of contacts identifies the inserted test strip and therefore the appropriate testing protocol for analyte detection.

For purposes of testing, only some of the plurality of electrical contacts of the strip port connector are made active to interact with the corresponding test strip electrical contacts for purposes of analyte detection with regard to an applied sample using addressable switches or the like via control circuitry of the test meter.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “circuitry,” “module,” ‘subsystem” and/or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electrical, magnetic, optical, electromagnetic, infrared, or semiconductor system, apparatus, or device, or any suitable combination of the foregoing. More specific examples of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible, non-transitory medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Furthermore, the various methods described herein can be used to generate software codes using off-the-shelf software development tools. The methods, however, may be transformed into other software languages depending on the requirements and the availability of new software languages for coding the methods.

### PARTS LIST FOR FIGS. 1A-6

10 analyte measurement device
11 housing
13 data port
14 display
16 user interface buttons
22 port
24 test strip
100 analyte measurement system
101 memory module
102 user input module
103 user interface module
104 strip port connector (SPC)
105 settings module
106 wireless module
107 internal digital antennas
108 wireless transceiver circuit—WiFi
109 wireless transceiver circuit—Bluetooth
110 wireless transceiver circuit—NFC
111 wireless transceiver circuit—Cellular
112 volatile random access memory (RAM)
113 non-volatile memory
114 circuit
115 light source control module
116 power supply module
117 AC power supply
118 battery
119 display module
120 audio module
121 speaker
122 processing unit
123 electrical interface
125 analog front end (AFE)
140 data management unit (DMU)
200 strip port connector (SPC)
202 SPC body
204 recess or port
206 supports
208 contact printed circuit board (PCB)
210 SPC electrical contacts
212 main PCB
214 connector
216 test strip
302 array
304 contacts (SPC)
306 PCB
308 electrical contacts (test strip)
310 SPC contacts in physical contact with test strip contacts
312 SPC contacts not in physical contact with test strip contacts
402 electrical contacts (SPC)
404 addressable switch
500 test strip
502 strip edge
504 strip edge
506 test strip surface
508 electrical contact areas (test strip)
510 contact alignment bar
600 method
602 step
604 step
606 step
608 step

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well.

What is claimed is:

1. An analyte measurement system, comprising:
a plurality of test strips, each test strip comprising a series of electrical contacts disposed on a substantially planar surface; and
a test meter comprising:
a strip port connector configured to receive a said test strip and having a plurality of spaced electrical contacts disposed in an array upon a printed circuit board (PCB),
wherein upon insertion of a said test strip in the strip port connector, at least some of the plurality of spaced electrical contacts of the strip port connector are caused to engage each of the electrical contacts of the inserted test strip and in which the array of electrical contacts of the strip port connector are disposed in parallel relation to the substantially planar surface of the inserted test strip.

2. The analyte measurement system of claim 1, wherein only the spaced contacts of the strip port connector engaged with the electrical contacts of the inserted test strip are activated by a control circuit of the test meter.

3. The analyte measurement system of claim 1, wherein the array of contacts of the strip port connector are initially disposed in a first position and are caused to move into a second position that creates compressive contact with the electrical contacts of the test strip following insertion of the test strip.

4. The analyte measurement system of claim 3, wherein the strip port connector further comprises a positioning device to move the PCB from the first position to the second position.

5. The analyte measurement system of claim 1, wherein the test strip is releasably inserted into the test meter and in which the contacts of the strip port connector releasably engage the electrical contacts of the test strip.

6. The analyte measurement system of claim 1, further comprising an addressable switch coupled to each of the plurality of spaced contacts of the strip port connector, the addressable switches being connected to at least one control circuit of the test meter and configured to selectively activate the spaced contacts in contact with the electrical contacts of the inserted test strip.

7. The analyte measurement system of claim 1, wherein each test strip comprises at least one contact alignment feature configured to align the test strip in the strip port connector.

8. The analyte measurement system of claim 1, wherein a relative spacing between adjacent contacts of the strip port connector is at least twice a relative spacing between the electrical contacts of an inserted test strip.

9. The analyte measurement system of claim 1, wherein the printed circuit board is flexibly coupled to at least one control circuit.

10. The analyte measurement system of claim 1, wherein the array of spaced electrical contacts of the strip port connector is a one dimensional linear array.

11. The analyte measurement system of claim 1, wherein the array of spaced electrical contacts of the strip port connector is a two dimensional array.

12. A universal strip port connector configured to receive a test strip in an analyte measurement device, the test strip including a substantially planar surface having electrical contacts disposed thereon, the strip port connector comprising:
a plurality of spaced electrical contacts disposed in an array upon a printed circuit board (PCB);
wherein at least some of the plurality of electrical contacts are configured to compressively engage the electrical contacts of the test strip upon insertion thereof; and
wherein the array of spaced electrical contacts of the strip port connector are disposed in a parallel relationship to the substantially planar surface of the inserted test strip.

13. The universal strip port connector of claim 12, wherein only the spaced electrical contacts placed in compressive contact with the test strip electrical contacts are activated by a control circuit of the test meter.

14. The universal strip port connector of claim 12, further comprising a positioning device to move the PCB from a first position to a second position, in a direction substantially transverse to an insertion direction of the test strip, to engage the array of spaced electrical contacts with the electrical contacts of the inserted test strip electrical contacts.

15. The universal strip port connector of claim 12, further comprising an addressable switch coupled to each of the plurality of spaced electrical contacts, the addressable switches being connected to at least one control circuit of the test meter configured to selectively activate the spaced contacts in contact with the contacts of the inserted test strip.

16. The universal strip port connector of claim 12, wherein a relative spacing between adjacent contacts of the plurality of spaced electrical contacts is at least twice a relative spacing between adjacent electrical contacts of the test strip.

17. The universal strip port connector of claim 12, wherein the array comprises a one-dimensional (1D) linear array.

18. The universal strip port connector of claim 12, wherein the array comprises a two-dimensional (2D) array.

19. The universal strip port connector of claim 12, wherein the contacts of the strip port connector releasably engage the electrical contacts of the test strip.

20. A method for operating an analyte measurement system comprising a test meter having a strip port connector sized to receive a test strip, the strip port connector comprising a plurality of spaced electrical contacts disposed in an array upon a printed circuit board (PCB), the method comprising:
inserting a test strip into the strip port connector, the test strip comprising a series of electrical contacts arranged on a substantially planar surface and the test strip being inserted such that the array of spaced electrical contacts is disposed in parallel relation to the substantially planar surface of the inserted test strip;
engaging at least some of the plurality of test strip electrical contacts of the strip port connector with each of the electrical contacts of the inserted test strip;
determining a pattern of electrical contacts of the test strip to identify the inserted test strip; and
activating only the electrical contacts of the strip port connector that are in contact with the electrical contacts of the inserted test strip.
